(19) United States
(12) Patent Application Publication
(10) Pub. No.: US 2008/0224344 A1
(43) Pub. Date: Sep. 18, 2008

(54) Method of making a cemented carbide body

(75) Inventors: Kenneth Westergren, Hagersten (SE); Marian Mikus, Skarholmen (SE); Leif Akesson, Alvsjo (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB

(21) Appl. No.: 12/073,934

(22) Filed: Mar. 12, 2008

(30) Foreign Application Priority Data
Mar. 13, 2007 (SE) 0700602-6

(51) Int. Cl. B29C 67/04; B29C 35/02

(52) U.S. Cl. 264/109

(57) ABSTRACT

The present invention relates to a method of making a cemented carbide body.

The body is made using conventional powder metallurgical methods such as milling, pressing and sintering. According to the invention, a combined sintering process is used comprising at least a sequence where the batch of bodies in the sintering furnace is heated to a sintering temperature at least above the melting point of the binder phase. The batch of bodies in the sintering furnace is then allowed to cool down to a temperature at least below the melting point of the binder phase and kept there for at least from about 1 but preferably less than about 30 minutes and then heated up again to a sintering temperature at least above the binder phase melting point.

The present invention also relates to a cemented carbide body made according to the method.

### BACKGROUND OF THE INVENTION

The present invention relates to a method of making a cemented carbide body. Bodies made according to the method obtain a well balanced combination of toughness and resistance against wear and plastic deformation.

Cemented carbide inserts with surface zones enriched in binder phase but depleted of gamma phase, also referred as gradient zones, are today used to a great extent for machining of steel and stainless materials. Through the binder phase enriched surface zone, an extension of the application area regarding increasing toughness without a decrease of resistance to plastic deformation at high cutting temperatures is possible to obtain.

Methods of producing binder phase enriched surface zones on cemented carbides inserts containing WC, cubic carbide phase and binder phase are known as gradient sintering and are disclosed in, e.g., U.S. Pat. No. 4,277,283, U.S. Pat. No. 4,610,931 and U.S. Pat. No. 4,548,786.

The above mentioned patents describe methods to accomplish binder phase enrichment by dissolution of the cubic carbide phase close to the insert surfaces. These methods require that the cubic carbide phase contains some nitrogen, since dissolution of cubic carbide phase at the sintering temperature requires a partial pressure of nitrogen, nitrogen activity, within the body being sintered, exceeding the partial pressure of nitrogen within the sintering atmosphere. The nitrogen can be added through the powder and/or the furnace atmosphere during the sintering cycle. The dissolution of cubic carbide phase results in small volumes that will be filled with binder phase giving the desired binder phase enrichment. As a result, a surface zone generally up to 35 μm thick, comprising essentially WC and binder phase is obtained. Although the cubic carbide phase is essentially a carbonitride phase, the material is herein referred to as cemented carbide.

By making inserts with different binder phase enriched surface zones, with regard to thickness of the zone and Co-content, relative to that in the inner portion of the insert, inserts optimized for varying machining operations can be designed. If a thicker gradient is desired, a cemented carbide composition with higher carbon content is chosen. This, however, leads to a decrease in plastic deformation resistance particularly at high productivity machining using high cutting speeds and large feed rates, generating high edge temperatures. Alternatively, a cemented carbide with a higher nitride-to-cubic carbide ratio can be chosen. Adding more nitride, however, leads to certain increased sintering problems, which can result in increased porosity level. Another way of making a thicker gradient zone is to use less cubic carbide phase. However, this also leads to change in properties, such as reduced resistance to plastic deformation at elevated temperatures.

Sintering of cemented carbide bodies is an expensive production step. It is therefore performed at lowest possible temperature for shortest possible time to obtain the desired microstructure.

U.S. Pat. No. 4,610,931 discloses resintering of binder phase enriched cemented carbide inserts in order to recreate the binder phase enriched zone after the original has been removed by grinding.

U.S. Pat. No. 5,761,593 and U.S. Pat. No. 5,484,468 disclose a subsequent heat treatment in nitrogen of a binder phase in order to modify further the properties of binder phase enriched cemented carbide inserts.

US 2002/174750 discloses uncoated cemented carbide inserts for which improved properties have been obtained by an additional heat treatment after sintering i.e. a resintering treatment.

U.S. Pat. No. 6,110,603 discloses a method of producing a surface layer sequence which improves the wear resistance of a cermet or hard-metal. The sintering process according to the method comprises a sequence where the temperature is cycled several times, 50° C. above and 50° C. degrees below, the eutectic melting point. The aim is to obtain a surface zone with three different layers. The outermost layer, that forms the surface of the body, has a substantially binder-phase free carbonitride phase of a depth of 2-30 μm from the surface. The second layer has a thickness of 5-150 μm and is composed of a pure WC—Co composition. The third and innermost layer is 10-650 μm thick and the proportions of the binder phase and a Group IVa or Group Va metals in the third layer increase toward the interior and the tungsten proportion decreases toward the interior.

### OBJECTS AND SUMMARY OF THE INVENTION

It is an object of the present invention to provide a method of making a cemented carbide body with further improved toughness without loss of resistance to plastic deformation over the toughness obtained by known sintering methods.

It is an object of the present invention to provide a method of making a cemented carbide body with a low porosity level.

In one embodiment of the present invention, there is provided a method of making a cemented carbide body comprising the steps of providing a compacted body and sintering said body in vacuum, or in an inert atmosphere at low pressure less than 60 mbar, using a combined sintering process wherein the combined sintering process comprises at least one sequence where the batch of bodies in the sintering furnace is heated to a sintering temperature, at least above the melting point of the binder phase, and the batch of bodies is then, while still in the furnace, allowed to cool down to a temperature at least below the melting point of the binder phase and kept there for at least from about 1 but preferably less than about 30 minutes and, then heated up again to a sintering temperature at least above the melting point of the binder phase.

In another embodiment of the invention, there is provided a cemented carbide body made according to the method.

### BRIEF DESCRIPTION OF THE DRAWINGS

FIG. 1A is an SEM backscattered electron image of the binder phase enriched surface zone from the polished crossed-section of an insert according to invention.

FIG. 2A is an SEM backscattered electron image of the binder phase enriched surface zone from the polished crossed-section of an insert according to prior art.

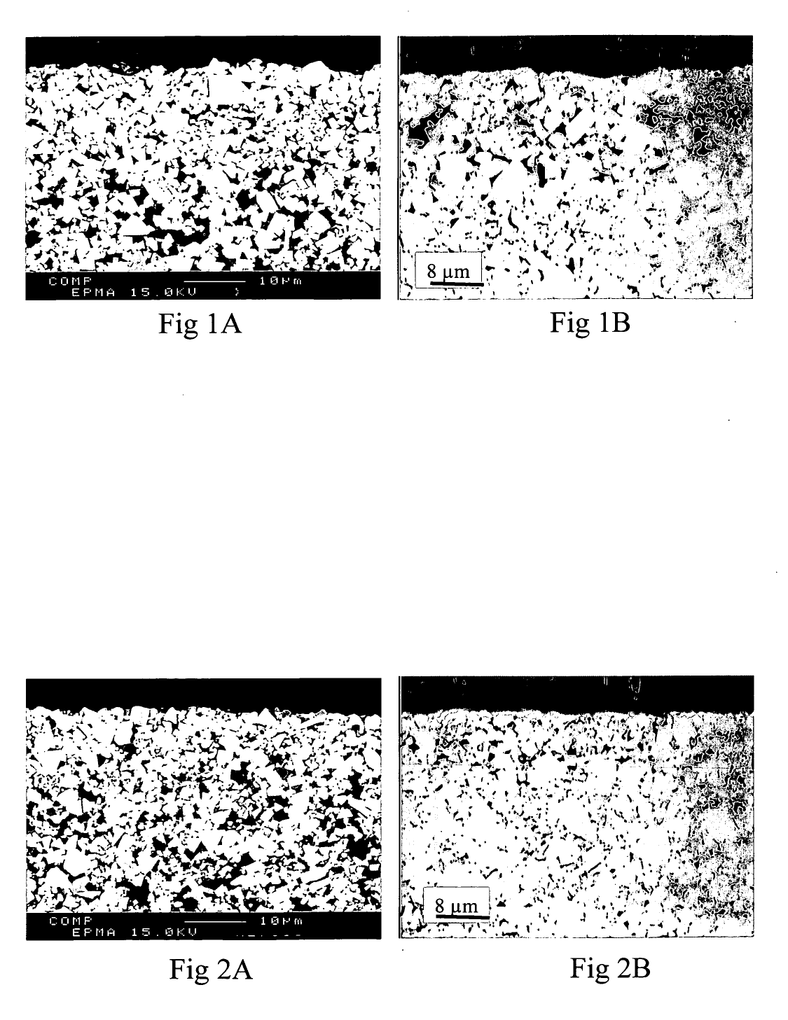

In FIGS. 1A and 2A, the white phase is a WC phase, the medium grey phase is a cubic carbide or carbonitride phase also called gamma phase and the dark grey to black phase is the Co binder phase.

FIG. 1B is a light optical microscope image of the binder phase enriched surface zone from the polished and Nital etched crossed-section of an insert according to invention.

FIG. 2B is a light optical microscope image of the binder phase enriched surface zone from the polished and Nital etched crossed-section of an insert according to prior art.

In FIGS. 1B and 2B, the black areas correspond to Co binder phase, the rest, medium grey areas are formed by WC and cubic carbide or carbonitride phase often referred to as gamma phase.

### DETAILED DESCRIPTION OF THE PRESENT INVENTION

It has now surprisingly been found that improved toughness in combination with high resistance to plastic deformation and low porosity is obtained by a combined sintering process.

The present invention relates to a method of making a cemented carbide body comprising the steps of:

providing a compacted body,

sintering said body in vacuum, or in an inert atmosphere at low pressure less than 60 mbar, using a combined sintering process.

The combined sintering process comprises at least one sequence where the batch of bodies in the sintering furnace is heated to a sintering temperature at least above the melting point of the binder phase. The batch of bodies is then, while still in the furnace, allowed to cool down to a temperature at least below the melting point of the binder phase and kept there for at least from about 1 but preferably less than about 30 minutes and, then heated up again to a sintering temperature at least above the binder phase melting point. In this process, nitrogen gas is a reactive gas.

As a result, sintered cemented carbide bodies are obtained combining high toughness and deformation resistance with a low porosity level. Cemented carbide bodies, e.g. cemented carbide cutting tool inserts, made according to the invention can be provided with sharper cutting edges and thicker coatings.

The melting point of the binder phase can vary depending on the amount of added alloying elements and possible impurities. Normally, the binder phase melting point is found in the interval from about 1150° C. to about 1450° C. During the sintering sequence where the bodies is allowed to cool down to a temperature at least below the melting point of the binder phase they should preferably not be allowed to cool down below about 800° C.

In one embodiment of the present invention the combined sintering process, which is from about 1.5 to about 3 times longer than that needed to obtain a dense body at the chosen temperature, comprises three steps. During the first step, the sintering furnace is heated to the desired sintering temperature at least above the melting point of the binder phase and kept there for from about 40 to about 80% of the total sintering process time. The batch of the bodies in the sintering furnace is then, during the second step, allowed to cool down to a temperature at least below the melting point of the binder phase and kept there for at least from about 1 but preferably less than about 30 minutes and then finally heated up again to a sintering temperature at least above the melting point of the binder phase and kept there for the remaining sintering time, preferably for about the same time as that prior to the temperature decrease.

In one embodiment of the present invention, the combined sintering process comprises at least two, but less than about 6, sequences comprising a temperature decrease.

In one embodiment, the present invention relates to a method of making a coated cemented carbide cutting tool insert comprising the following steps:

forming a powder mixture containing powders forming hard constituents and binder phase,

adding to said powder mixture a pressing agent,

milling and drying the mixture to obtain a powder material ready to press,

compacting the powder to bodies,

sintering said bodies in vacuum, or in an inert atmosphere at low pressure, less than about 60 mbar, using the combined sintering process

applying conventional post sintering treatments including edge rounding to from about 30 to about 60 μm,

forming a hard, wear resistant coating of single or multiple layers of at least one carbide, nitride, carbonitride, oxide or boride of at least one metal of the groups IVB, VB and VIB of the periodic table and/or aluminum oxide by known CVD-, PVD- or MT-CVD-technique with a thickness of from about 10 to about 50 μm and, finally,

possibly treating the inserts by brushing or blasting.

In one embodiment of the present invention, the combined sintering process is performed in vacuum or in an inert atmosphere at low pressure less than about 60 mbar, at a temperature of from about 1400 to about 1500° C. for a period of time which is from about 1.5 to about 3 times longer than that needed to obtain a dense body at the chosen temperature.

In one embodiment of the present invention, the cemented carbide body comprises a binder phase of Co, WC and a cubic carbide and/or carbonitride phase. Further, the body has a Co binder phase enriched surface zone where said Co binder phase enriched surface zone is essentially free of said cubic phase.

In one embodiment of the present invention, the cemented carbide comprises from about 4 to about 8 wt-% Co binder phase, from about 2 to about 10 wt-% cubic carbide and/or carbonitride phase, rest WC phase, preferably from about 85 to about 92 wt-% WC phase. The carbon content is selected so that no free graphite or eta phase is present within the sintered bodies. The carbon content is expressed as the

CW-ratio=magnetic-% Co/wt-% Co

where magnetic-% Co is the weight percentage of magnetic Co and wt-% Co is the weight percentage of Co in the cemented carbide. The CW-value is a function of the W content in the Co binder phase. A CW-value of about 1 corresponds to a low W-content in the binder phase and a CW-value of from about 0.75 to about 0.8 correspond to a high W-content in the binder phase. The CW-ratio shall be from about 0.80 to about 0.90 and the coercive force from about 10 to about 15 kA/m.

The present invention also relates to a cemented carbide body made according to the method described above. The obtained body will be essentially free of pores.

In one embodiment of the present invention, the cemented carbide body is a cemented carbide cutting tool insert with a from about 10 to about 25 μm, preferably from about 15 to about 20 μm, thick binder phase enriched surface zone, essentially free from cubic carbide or carbonitride phases. The surface zone has an average binder phase content from about 1.3 to about 2.5 times higher than that of the inner portion of the insert. The thickness and binder phase content of the surface zone is measured at a distance about 0.5 mm from the edge line on the cemented carbide insert rake face. In addition, compared to cemented carbide inserts according to prior art, the structure contains less small WC-grains, the size of the gamma phase is increased and the gradient zone contains relatively large Co binder phase islands. The average size of the Co binder phase islands in the binder phase enriched surface zone in cemented carbide inserts made according to the invention is from about 0.7 to about 1.0 μm, the maximum size is from about 3 to about 4 μm, measured on polished and Nital etched cemented carbide inserts in an optical microscope at a magnification of 1500×. Etching time is about 15 minutes in a Nital etching reagent consisting of about 10% solution of HCl in methanol. The hardness within the central parts of the cemented carbide insert, shall be more than about 1500 HV3, preferably from about 1500 to about 1700 HV3.

In one embodiment of the present invention, the uncoated cemented carbide cutting tool insert has an edge radius of from about 30 to about 60 μm and a wear resistant coating with a thickness of from about 10 to about 50 μm, preferably from about 12 to about 25 μm, preferably comprising from about 5 to about 15 μm MT-CVD Ti(C,N) and from about 5 to about 15 μm α-Al₂O₃ and from about 0.5 to about 2 μm TiN. The coated insert are subjected to a post treatment by brushing or blasting. Preferably, the TiN coating on rake face is removed by blasting, but preserved on the clearance side.

The present invention also relates to the use of a coated cemented carbide cutting tool insert in turning roughing operations of steel, such as ball bearing steel turning at cutting speed from about 150 to about 300 m/min, feed from about 0.5 to about 1.5 mm/rev, and depth of cut from about 2 to about 6 mm, preferably under wet conditions.

The invention is additionally illustrated in connection with the following examples, which are to be considered as illustrative of the present invention. It should be understood, however, that the invention is not limited to the specific details of the examples.

### EXAMPLE 1

X. Cemented carbide inserts of style SNMM 150624-31 with edge radius of 50 μm, substrates A-C with compositions according to Table 1, were produced in the conventional way from powders, which were milled, pressed and sintered at 1450° C. for 60 min.

Y. Part of the inserts from X was subjected to a heat treatment at 1450° C. for 60 min after being cooled down to room temperature.

Z. The same as the Y but the inserts were cooled down to 1000° C. and kept there for 15 minutes, before heating up again to 1450° C.

TABLE 1
Starting composition of the cemented carbide powder mixtures
(weight %).

| Subst. | Co | TiC | TaC | NbC | TiN | WC |
|---|---|---|---|---|---|---|
| A | 5.0 | 2.1 | 3.5 | 2.3 | 0.44 | Rest |
| B | 5.5 | 2.1 | 3.5 | 2.3 | 0.44 | Rest |
| B2 | 5.5 | 2.1 | 3.5 | 2.3 | 0.65 | Rest |
| C | 7.5 | 1.9 | 2.9 | 0.5 | 0.40 | Rest |
| D | 5.5 | 1.4 | 1.8 | 1.6 | 0.44 | Rest |

TABLE 2
Properties of substrates after various sintering types.

| Gradient- | | Grad. zone | Co binder phase | | | | |
|---|---|---|---|---|---|---|---|
| Type + | Sintering | thickn. | islands size | Figs | Hardn. | | Hc |
| Substrate | type | μm | Average-max (μm) | No | HV3 | Porosity | kA/m |
| 1/A, | Y. Comb. | 14 | 0.9-3.0 | — | 1595 | A00-A02 | 14.9 |
| invention | | | | | | | |
| 2/A, | X. Conv. | 7 | 0.6-1.7 | — | 1620 | A02-A04 | 14.9 |
| prior art | | | | | | | |
| 3/B, | Y. Comb. | 18 | 0.9-3.5 | 1A, 1B | 1535 | A00 | 13.8 |
| invention | | | | | | | |
| 4/B, | X. Conv. | 9 | 0.7-2.0 | 2A, 2B | 1564 | A00 | 13.7 |
| prior art | | | | | | | |
| 5/B, | X. Conv. | 16 | 0.7-2.2 | — | 1560 | A04 | 13.5 |
| prior art | | | | | | | |
| 6/C, | X. Conv. | 26 | 0.7-2.3 | — | 1500 | A04 | 13.4 |
| prior art | | | | | | | |
| 7/D, | X. Conv. | 18 | 0.7-2.4 | — | 1530 | A02-A04 | 13.9 |
| prior art | | | | | | | |
| 8/B, | Z. Comb. | 19 | 0.9-3.4 | — | 1540 | A00 | 13.7 |
| invention | | | | | | | |

All inserts in Table 2 were coated with 7 μm MT-CVD Ti(C,N) 10 μm α-Al₂O₃ and 0.5 μm TiN. In the MT CVD Ti(C,N) coating process acetonitrile was used as carbon and nitrogen source at 885° C. After coating, the inserts were blasted with Al₂O₃-grains resulting in that the TiN layer was removed on the rake face and preserved on the clearance side.

### EXAMPLE 2

The inserts from Example 1 were subjected to a machining test with the following data:

| | |
|---|---|
| Workpiece: | Ballbearingsteel ring SS2258, inner |
| | diameter 390 and outer diameter 440 mm. |
| | Length: 250 mm/ring |
| Type of operation: | External and internal turning operation |
| Cutting speed: | 225 m/min inner diameter, 250 m/min outer |
| | diameter. |
| Depth of cut: | 3-4 mm |
| Feed: | 0.7-0.9 mm/rev |
| Coolant: | wet operation |

Tool life criterion:
Life time 18 rings per edge, 20 edges/variant tested
Number of edges without fracture or VB<0.5 mm until 18 rings

| | Tool life | |
|---|---|---|
| | Number of edges | |
| Insert No | With full tool life | Comments |
| 1/A.-invention (comb. sint.) | 16 | 4 Edge fracture |
| 2/A.-prior art (conv. sint.) | 0 | 20 Edge fracture |
| 3/B.-invention (comb. sint.) | 20 | |
| 4/B.-prior art (conv. sint.) | 0 | 20 Edge fracture |
| 5/B2-prior art (conv. sint.) | 10 | |
| 6/C.-prior art (conv. sint) | 0 | 20 VB > 0.5 mm |
| 7/D.-prior art (conv. sint.) | 6 | 14 Edge fracture |
| 8/B.-invention (comb. Sint.) | 19 | |

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A method of making a cemented carbide body comprising the steps of:
providing a compacted body; and.
sintering said body in vacuum or in an inert atmosphere at low pressure less than 60 mbar,
wherein the sintering is performed by a combined sintering process comprising at least one sequence where the batch of bodies in the sintering furnace is heated to a sintering temperature at least above the melting point of the binder phase and is then, while still in the furnace, allowed to cool down to a temperature at least below the melting point of the binder phase and kept there for at least from about 1 but less than about 30 minutes and then heated up again to a sintering temperature at least above the binder phase melting point.

2. A method of claim 1, wherein the batch of bodies in the sintering furnace is allowed to cool down after from about 40 to about 80% of the total sintering process time.

3. A method of claim 1, wherein the cemented carbide body is a cemented carbide cutting tool insert.

4. A method of claim 3, wherein the cemented carbide cutting tool insert has a Co binder phase enriched surface zone.

5. A method of claim 1, wherein the sintering is performed for a period of time which is from about 1.5 to about 3 times longer than that needed to obtain a dense body at the chosen temperature.

6. A method of claim 1, wherein the cemented carbide comprises 4-8 wt-% Co binder phase, 2-10 wt-% cubic carbide and/or carbonitride phase, rest WC phase, and having a coercive force of 10-15 kA/m.

7. A method of claim 1, wherein the cemented carbide body is a coated cemented carbide cutting tool insert with a coating comprising single or multiple layers of at least one carbide, nitride, carbonitride, oxide or boride of at least one metal of the groups IVB, VB and VIB of the periodic table and/or aluminum oxide.

8. A cemented carbide body made according to the method of claim 1.
